(19) United States
(12) Patent Application Publication
(10) Pub. No.: US 2007/0236917 A1
(43) Pub. Date: Oct. 11, 2007

(54) Lighted soft touch buckle for restraint system

(75) Inventors: Mark F. Gray, Sterling Heights, MI (US); Paul M. Smith, Davison, MI (US)

Correspondence Address: FOLEY AND LARDNER LLP;SUITE 500, 3000 K STREET NW, WASHINGTON, DC, 20007, US

(73) Assignee: TK HOLDINGS INC

(21) Appl. No.: 11/730,868

(22) Filed: Apr. 4, 2007

Related U.S. Application Data
(60) Provisional application No. 60/744,485, filed on Apr. 7, 2006.

(51) Int. Cl. F21V 21/108; B60R 22/00; A44B 11/25

(52) U.S. Cl. 362/108; 362/483; 362/511; 280/801.1; 24/633

(57) ABSTRACT

An occupant restraint system with an illuminable portion and/or thermal source integrated therein.

### CROSS-REFERENCE TO RELATED PATENT APPLICATIONS

This application claims priority from U.S. Provisional Application No. 60/744,485, filed Apr. 7, 2006, incorporated herein by reference in its entirety.

### TECHNICAL FIELD

This application generally relates to the field of occupant restraint systems. More particularly, this application relates to an occupant restraint system having a tongue and buckle assembly with an integrated illuminable portion and/or thermal source.

### BACKGROUND

Occupant restraint systems for vehicles typically include a matable tongue and buckle assembly configured to secure the vehicle occupant to the seat, particularly during rapid acceleration and deceleration. Tongues typically include a striker portion composed of a stamped chrome material and a housing composed of a hard plastic. Alternatively, the tongue housing may be composed of a deformable material to increase user comfort and reduce noise.

It may be difficult to locate the buckle and/or the tongue when they are in poorly lit areas of the vehicle interior. Some vehicles include a flashlight, overhead lighting or other external light sources to assist vehicle users in locating the tongue or buckle. Still, such external light sources can require multiple hands to simultaneously operate the light source and buckle the seat belt, which can be cumbersome for vehicle users.

Other vehicles include light sources incorporated within the buckle that exude light from translucent buttons and/or ejectors. Material selections for the buttons and ejectors are thus limited to translucent materials. The light is also not uniformly distributed due to the position of the light source with respect to the complex shapes of the buckle housing.

Also, upon reaching excessively cold or excessively warm temperatures, the buckle may be uncomfortable for vehicle users to handle.

Therefore, it is desirable incorporate a light source integrated in the buckle housing. It is also desirable, to include a thermal source which selectively heats or cools the buckle.

### SUMMARY

One exemplary embodiment includes a vehicle occupant restraint system, including: a belt configured to extend and retract across a vehicle occupant; a tongue coupled to the belt; a buckle housing that includes a latch configured to attach the tongue inside the buckle housing; and an illuminable portion within the buckle housing configured to selectively uniformly distribute light.

One exemplary embodiment includes a vehicle occupant restraint system, including: a belt configured to extend and retract across a vehicle occupant; a tongue coupled to the belt; a buckle housing that includes a latch configured to attach the tongue inside the buckle housing; and a thermal source attached to the buckle housing to selectively increase and/or decrease the temperature of the buckle housing.

One exemplary embodiment includes a buckle housing for an occupant restraint system, including: a latch configured to attach a tongue inside the buckle housing; and an illuminable portion within the buckle housing configured to selectively uniformly distribute light.

### BRIEF DESCRIPTION OF DRAWINGS

The accompanying drawings, which are incorporated in and constitute a part of this specification, illustrate preferred embodiments of the invention and together with the description serve to explain principles of the invention.

FIG. 1 is a schematic depiction of a vehicle having an occupant restraint system according to an exemplary embodiment.

FIG. 2 is a perspective view of a tongue and buckle of an occupant restraint system according to an exemplary embodiment.

FIG. 3 is a side elevation view of the buckle according to an exemplary embodiment.

FIG. 4 is a side elevation view of the buckle through line 4-4 of FIG. 3.

FIG. 5 is a side elevation view of a buckle having an electroluminescent lamp according to an exemplary embodiment.

FIG. 6 is a schematic depiction of the buckle having a light source and thermal source according to an exemplary embodiment.

FIG. 7 is a schematic depiction of the buckle having a switch and sensor remotely located according to an exemplary embodiment.

### DESCRIPTION

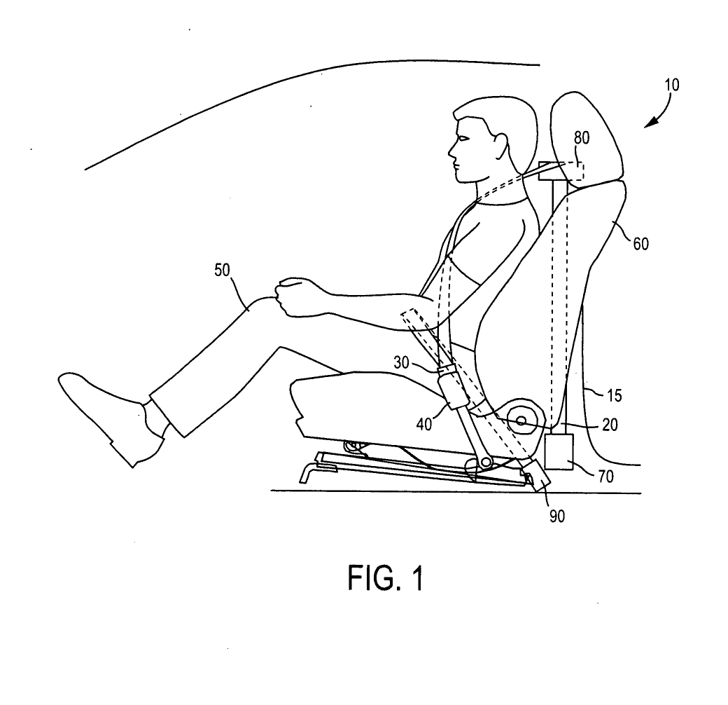

FIG. 1 illustrates a vehicle occupant restraint system 10 for use in a passenger vehicle 15, such as e.g., an automobile, plane, train and/or child seat. The occupant restraint system 10 generally includes a belt 20, a tongue 30 and a matable buckle 40. Upon attaching the tongue 30 to the buckle 40, the belt 20 is latched across the vehicle occupant 50 to secure the occupant to the vehicle seat 60. At one location in the vehicle, the belt 20 is attached to a seat belt retractor 70. The belt 20 is guided through a shoulder anchor 80 and attached to a fixed floor anchor 90. The occupant restraint system 10 also includes an illuminable portion configured to exude light, thereby providing light to vehicle users when buckling and unbuckling the occupant restraint system 10.

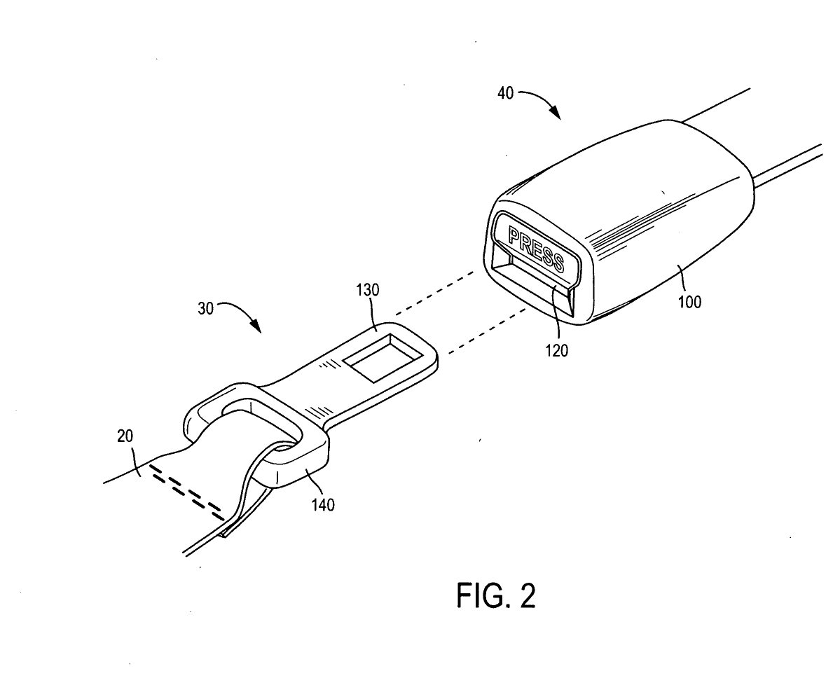

The belt 20 is configured to extend and retract across the vehicle occupant 50 when seated. The belt 20 can be composed of a nylon material, which is threaded through a tongue housing 140 (as shown in FIG. 2). The tongue 30 slides with respect to the belt 20 when in an unbuckled position. The belt 20 is connected to a belt retractor 70 assembly that is configured to guide the belt between winding and unwinding. The retractor assembly 70 includes a plurality of springs (not shown) configured to pretension the belt 20 in the winding direction.

The buckle 40 is fixed with respect to the vehicle 15. In one exemplary embodiment, the buckle 40 is anchored to the vehicle frame so that the seat belt is secured or locked in place when it is attached to the buckle. The buckle 40 includes a buckle housing 100 as shown in FIG. 2.

The buckle housing 100 includes a latch 120 (as shown in FIG. 2) to prevent unwanted disengagement of the tongue. The latch 120 is configured to secure a striker portion 130 of the tongue. The latch 120 is further configured to selectively release the tongue 30 either manually or automatically. One example of an automatically releasable buckle and latch is disclosed U.S. Pat. No. 5,359,756, entitled, “Automatic Buckling Device” which is commonly assigned and herein incorporated by reference. The buckle housing 100 may be composed of, for example, a hard plastic and/or foam.

The tongue 30 includes a striker portion 130 and a housing portion 140. The tongue housing 140 may be composed of a hard plastic, soft foam and/or rubber material configured to deform upon applying pressure. The striker portion 130 can be located on the perimeter of the tongue. The striker portion 130 is configured to attach or hook into the latch of the buckle upon engagement, thereby securing the tongue 30 and belt to the buckle. The striker portion may be composed of chromatic steel.

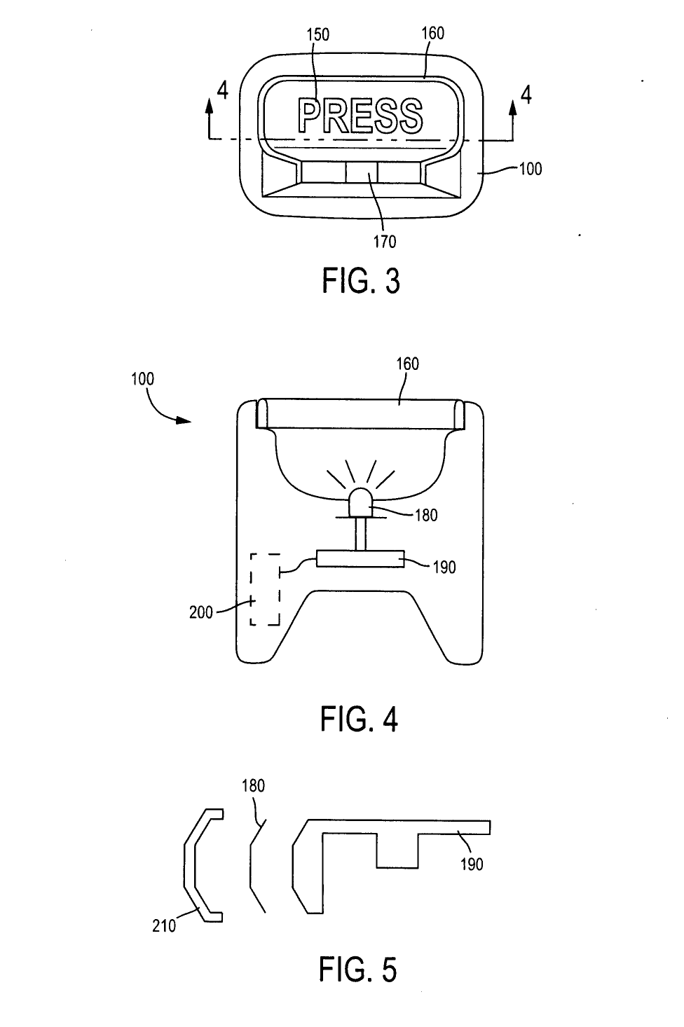

In one exemplary embodiment, the buckle housing 100 may be labeled with instructions to the user as shown in FIG. 3 (e.g., “Press”). The labeling can be done in phosphorescent ink so that it may illuminate in the dark. In another exemplary embodiment, an illuminable portion 160 is incorporated within the buckle housing 100 and is configured to exude light. The illuminable portion 160 includes at least one light source 180 which is actuated by a switch 190, as shown in FIG. 4. The switch 190 may be any switch known within the art including but not limited to a circuit breaker, mercury switch, wafer switch, DIP switch, surface mount switch, reed switch, toggle switch, push-button switch, touch-activated switch and/or microswitch.

In one exemplary embodiment, as shown in FIG. 5, the switch 190 is membrane switch which includes an interior and exterior portion. The exterior portion of the membrane switch is configured to interact with the vehicle users' hands and/or fingers. The interior portion includes a surface having a pattern and/or protrusion configured to complete an electrical circuit connecting a power source and the light source 180. The surface may be, for example, a touch plate composed of an electrically conductive material such as copper. The (membrane) switch 190 is deformable (or movable) with respect to the buckle housing 100 and, upon moving the touch plate with respect to the buckle housing, the touch plate interacts with electrical connectors mounted within the buckle housing to complete the electrical circuit and power the light source. One example of a membrane switch is disclosed in U.S. Pat. No. 6,797,906, entitled, “Membrane Switch, Key Switch Using Membrane Switch, Keyboard Having Key Switches, and Personal Computer Having Keyboard” which is herein incorporated by reference in its entirety. In another exemplary embodiment, a toggle switch is used to control the light source 180. The toggle switch enables the light source to emanate light linearly (or at various levels). In another exemplary embodiment, a touch activated switch can be incorporated into the buckle housing. As the occupant reaches for and makes contact with the buckle the switch activates the illuminable portion. An additional switch can be provided to deactivate the illuminable portion.

The illuminable portion, as shown in FIG. 5, includes a light source 180 (such as an electroluminescent lamp) attached to the buckle housing 100. When the vehicle occupant handles the buckle, the light source 180 emits light in a direction outward with respect to the buckle housing 100. A lamp cover 210 is coupled to the buckle housing 100. A switch 190 or button interfaces with the light source 180 to turn the light source on and off. One example of an electroluminescent lamp is disclosed in U.S. Pat. No. 7,019,458, entitled, “Electroluminescent Display Device” which is herein incorporated by reference in its entirety. In another exemplary embodiment, a light source 180 is incorporated into the buckle housing 100 as shown in FIG. 4. The light source 180 is an LED, and a light ring or an otherwise illuminable portion 160 is coupled to the buckle housing 100 through which light emitted by the LED may be directed. The light source(s) may be any number of light sources which include but are not limited to incandescent light bulbs, LEDs, and/or fiber optics. In one exemplary embodiment, the buckle 40 is attached to the vehicle frame via a bracket that includes a series of fiber optic wires attached thereto configured to transmit light from a source to the illuminable portion 160 of the occupant restraint system 10. An example of fiber optic wiring is disclosed in U.S. Pat. No. 6,854,869, entitled, “LED Fiber Optic Illuminated Vehicle Seat Cover” which is herein incorporated by reference in its entirety.

The light source 180 is electrically powered by a power source 200, as shown in FIG. 4. The power source 200 may be incorporated within the buckle housing 100 as shown in FIG. 4, or it may be located remotely with respect to the buckle housing (e.g., the main power source for the vehicle). In one exemplary embodiment, the power source 200 is remotely located with respect to the buckle, and electrical wires are configured to extend throughout a bracket by which the buckle 40 is mounted to the seat 60 to provide power to the illuminable portion 160 of the buckle. The power source 200 can be a battery. The battery may be any battery known within the field such as, for example, an alkaline, NiMH, or lithium battery. In one exemplary embodiment, the power source is rechargeable.

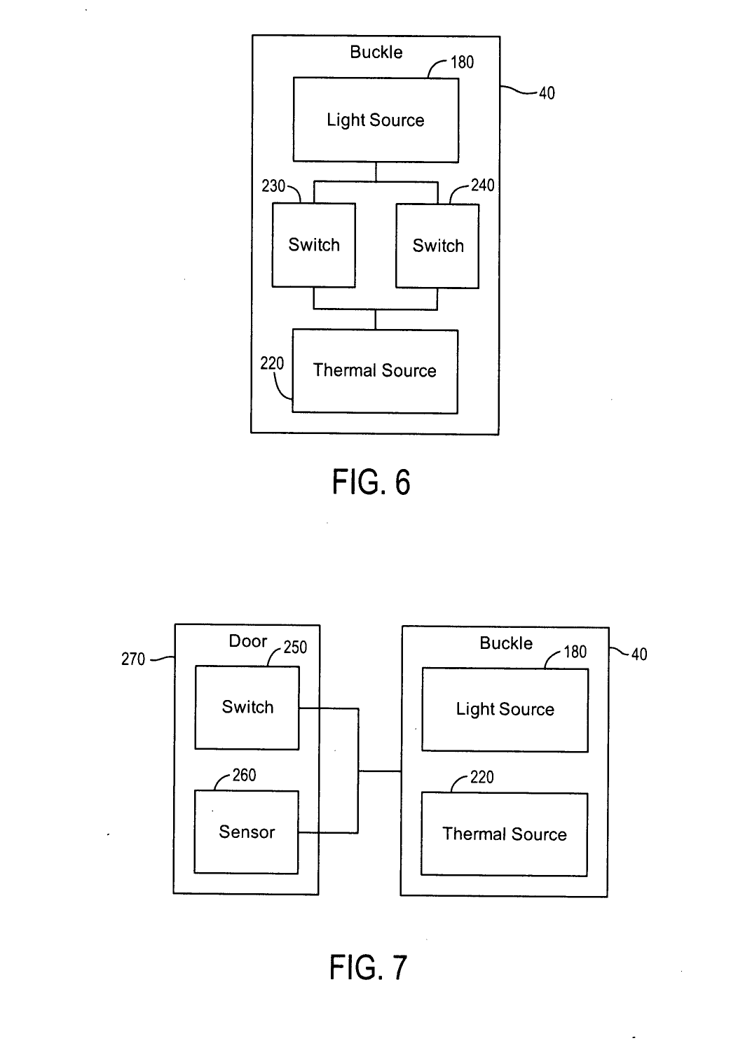

Referring now to FIG. 6, the buckle 40 includes a thermal source 220 to increase and/or decrease the temperature of the buckle and/or buckle housing. In one exemplary embodiment, thermal source 220 is actuated by a switch 230. The switch 230 may be any switch known within the art including but not limited to a circuit breaker, mercury switch, wafer switch, DIP switch, surface mount switch, reed switch, toggle switch, push-button switch, and/or microswitch. In one exemplary embodiment, the thermal source 220 is actuated by a membrane switch as described above. In another exemplary embodiment, the buckle 40 includes a thermocouple or sensor 240 configured to measure the temperature of the buckle housing and/or the ambient temperature. Upon measuring a temperature in excess of a predetermined threshold, the thermal source 220 may provide heat (acting as a heat source) or remove heat from the buckle (acting as a heat sink). For example, when operating the vehicle in locations such as Phoenix, Ariz. in the summer months, the thermal source 220 is configured to cool the buckle 40 upon sensing an ambient temperature greater than 90° F. Likewise, when operating the vehicle in locations such as Juneau, Ak., the thermal source 220 is configured to heat the buckle when the ambient temperature falls below 0° F. The thermal source 220 is coupled to an electrical power source. The power source 200 may be located remotely or incorporated within the buckle housing 100. The power source may include any type of power source. In one exemplary embodiment, the power source is a battery. The battery may be any battery known within the field such as, for example, an alkaline, NiMH or lithium battery. In one exemplary embodiment, the power source is rechargeable.

In one exemplary embodiment, the occupant restraint system includes a switch located remotely with respect to the buckle 40 as shown in FIG. 7. For example, a switch 250 and/or sensor 260 (e.g. a thermocouple) may be incorporated into the latch and striker assembly of the vehicle door 270 so that the light source and/or thermal source are configured to automatically activate upon opening the vehicle door. In another exemplary embodiment, the switch is located within the door locking mechanism so that the illuminable portion and/or thermal source are configured to automatically activate upon unlocking the vehicle door.

While exemplary embodiments are illustrated in the figures and described above, it should be understood that these embodiments are offered by way of example only. For example, the teachings herein can be applied to any latching assembly and are not limited to a vehicle occupant restraint system.

What is claimed is:

1. A vehicle occupant restraint system, comprising:
a belt configured to extend and retract across a vehicle occupant;
a tongue coupled to the belt;
a buckle housing that includes a latch configured to attach the tongue inside the buckle housing; and
an illuminable portion within the buckle housing configured to selectively uniformly distribute light.

2. The occupant restraint system of claim 1, wherein the buckle housing is labeled; and
wherein the labeling is done in phosphorescent ink.

3. The occupant restraint system of claim 1, wherein the illuminable portion includes a light source.

4. The occupant restraint system of claim 3, further comprising:
a switch configured to actuate the light source.

5. The occupant restraint system of claim 4, wherein the switch is a membrane switch movable with respect to the buckle housing.

6. The occupant restraint system of claim 4, wherein the switch is incorporated into a vehicle door configured to activate upon opening the vehicle door.

7. The occupant restraint system of claim 1, wherein the illuminable portion includes phosphorescent ink.

8. The occupant restraint system of claim 1, wherein the illuminable portion includes a light source coupled to the buckle housing.

9. The occupant restraint system of claim 1, wherein the illuminable portion is a light ring encircling at least a portion of the buckle housing.

10. The occupant restraint system of claim 1, further comprising:
a thermal source attached to the buckle housing to selectively increase and/or decrease the temperature of the buckle housing.

11. A vehicle occupant restraint system, comprising:
a belt configured to extend and retract across a vehicle occupant;
a tongue coupled to the belt;
a buckle housing that includes a latch configured to attach the tongue inside the buckle housing; and
a thermal source attached to the buckle housing to selectively increase and/or decrease the temperature of the buckle housing.

12. The occupant restraint system of claim 11, wherein the buckle housing is labeled; and
wherein the labeling is done in phosphorescent ink.

13. The occupant restraint system of claim 11, further comprising:
a switch configured to actuate the thermal source.

14. The occupant restraint system of claim 13, wherein the switch is a membrane switch movable with respect to the buckle housing.

15. The occupant restraint system of claim 13, wherein the switch is incorporated into a vehicle door configured to activate upon opening the vehicle door.

16. The occupant restraint system of claim 13, further comprising:
a thermocouple, configured to measure a temperature, wherein the thermocouple is configured to activate the thermal source upon measuring a temperature beyond a predetermined threshold.

17. The occupant restraint system of claim 11, further comprising:
an illuminable portion within the buckle housing configured to selectively uniformly distribute light.

18. A buckle housing for an occupant restraint system, comprising:
a latch configured to attach a tongue inside the buckle housing; and
an illuminable portion within the buckle housing configured to selectively uniformly distribute light.

19. The buckle housing of claim 18, further comprising:
a thermal source within the buckle housing to control the temperature of the buckle housing.
